(19) United States
(12) Patent Application Publication
(10) Pub. No.: US 2013/0195017 A1
(43) Pub. Date: Aug. 1, 2013

(54) METHOD AND SYSTEM OF TRANSMITTING PACKET DATA UNITS OF MACHINE TYPE COMMUNICATION DEVICES OVER A NETWORK INTERFACE IN A LONG TERM EVOLUTION NETWORK

(71) Applicants: Satish Nanjunda Swamy Jamadagni, Byrasandra (IN); Rahul Suhas Vaidya, Byrasandra (IN); Sarvesha Anegundi Ganapathi, Byrasandra (IN)

(72) Inventors: Satish Nanjunda Swamy Jamadagni, Byrasandra (IN); Rahul Suhas Vaidya, Byrasandra (IN); Sarvesha Anegundi Ganapathi, Byrasandra (IN)

(73) Assignee: SAMSUNG ELECTRONICS CO., LTD., Suwon-si, Gyeonggi-do (KR)

(21) Appl. No.: 13/878,898

(22) PCT Filed: Oct. 12, 2011
(86) PCT No.: PCT/KR11/07583

§ 371 Date: Apr. 11, 2013

(30) Foreign Application Priority Data
Oct. 12, 2010 (IN) 3025/CHE/2010

(51) Int. Cl. H04W 28/06

(52) U.S. Cl. CPC H04W 28/065
USPC 370/328

(57) ABSTRACT

A method and an apparatus for transmitting Packet Data Units (PDUs) associated with Machine Type Communication (MTC) devices over a network interface in a long term evolution network are provided. The method includes aggregating Packet Data Units (PDUs), the aggregated PDUs being associated with at least one MTC device, by a first network entity in a Long Term Evolution (LTE) network environment, concatenating the aggregated PDUs associated with the at least one MTC device into a General Packet Radio Service (GPRS) Tunneling Protocol (GTP) PDU, and transmitting the GTP PDU, the GTP PDU including the concatenated PDUs, to a second network entity over a network interface connecting the first network entity and the second network entity.

### PRIORITY

This application is a National Stage application under 35 U.S.C. §371 of an International application filed on Oct. 12, 2011 and assigned application No. PCT/KR2011/007583, and claims the benefit under 35 U.S.C. §365(b) of a Indian patent application filed on Oct. 12, 2010 in the Indian Intellectual Property Office and assigned Serial No. 3025/CHE/2010, the entire disclosure of which is hereby incorporated by reference.

### BACKGROUND OF THE INVENTION

1. Field of the Invention

The present invention relates to the field of Machine Type Communication (MTC) systems. More particularly, the present invention relates to transmitting Packet Data Units (PDUs) associated with MTC systems and devices over a network interface in a Long Term Evolution (LTE) network environment.

2. Description of the Related Art

A Long Term Evolution (LTE) system is a type of a wireless network system that supports legacy devices as well as Machine-Type Communication (MTC) devices and systems in order to communicate Packet Switched (PS) data with a core network or an MTC server via an evolved Node B (eNodeB). Typically, in LTE, an eNodeB communicates PS data received from the legacy devices and/or MTC devices with a serving gateway via a S1-U interface and vice versa.

MTC, which may also be referred to as Machine-to-Machine (M2M) communication, is a form of data communication between devices, such as MTC devices and/or M2M devices, that do not need human interaction, unlike related-art devices, which need human interaction for executing operations. For example, in an M2M communication, an MTC device, such as a sensor, a smart-meter, or any other similar and/or suitable device, may capture event data which is then relayed through an eNodeB to an application residing in an MTC server for analysis and necessary action. M2M communication may be used in a variety of areas, such as smart metering systems, e.g., in applications related to power, gas, water, heating, grid control, and industrial metering, surveillance systems, order management, gaming machines, health care device communication, and any other similar and/or suitable electronic device communication. Additionally, M2M communication based on MTC technology may be used in areas such as customer service.

An LTE system may include an access network and a core network. The access network includes an eNodeB connected to the MTC devices while the core network consists of a plurality of network entities, such as a Mobility Management Entity (MME), a serving gateway, and a Packet Data Network (PDN) gateway. Each of these network entities may be connected to each other via standardized interfaces in order to allow multivendor interoperability. For example, the eNodeB and the serving gateway are connected via an S1-U interface while the serving gateway and the PDN gateway are connected via a S5 interface. It is to be noted that network deployments may provision more access network resources than the core network can handle. Accordingly, network congestion due to the access network and network congestion due to core network may be different.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method and system for transmitting packet data units of machine type communication devices in a long term evolution network environment.

With the increasing deployment of large number of Machine Type Communication (MTC) devices, the core network is expected to support a large number of MTC devices, which may be in the order of thousands or any other suitable number of devices. However, when an evolved Node B (eNodeB) transmits a large number of small Packet Data Units (PDUs), e.g., PDUs having a size of 20 KB, associated with the MTC devices to the serving gateway via an S1-U interface, the S1-U interface may get overloaded, thereby leading to clogging of the core network. The same may be the case when the serving gateway transmits large number of small sized PDUs to the Packet Data Network (PDN) gateway via an S5 interface.

According to an exemplary embodiment of the present invention, an MTC method is provided. The method includes aggregating PDUs, the aggregated PDUs being associated with at least one MTC device, by a first network entity in a Long Term Evolution (LTE) network environment, concatenating the aggregated PDUs associated with the at least one MTC device into a General Packet Radio Service (GPRS) Tunneling Protocol (GTP) PDU, and transmitting the GTP PDU, the GTP PDU including the concatenated PDUs, to a second network entity over a network interface connecting the first network entity and the second network entity.

According to another exemplary embodiment of the present invention, an MTC apparatus is provided. The apparatus includes a processor, and a memory coupled to the processor, wherein the memory includes a PDU concatenation module configured for aggregating Packet Data Units (PDUs) associated with at least one MTC device in a LTE network environment, concatenating the aggregated PDUs associated with the at least one MTC device into a GTP PDU; and transmitting the GTP PDU, the GTP PDU including the concatenated PDUs, to a network entity over at least one of an S1-U interface and an S5 interface.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

The above and other aspects, features, and advantages of certain exemplary embodiments of the present invention will be more apparent from the following description taken in conjunction with the accompanying drawings, in which:

FIG. 1 illustrates a block diagram of a Long Term Evolution (LTE) system, according to an exemplary embodiment of the present invention;

FIG. 2 is a flow diagram illustrating an exemplary method of notifying an aggregate Packet Data Unit (PDU) indication during a call establishment procedure, according to an exemplary embodiment of the present invention;

FIG. 3 is a flowchart illustrating an exemplary method of transmitting PDUs associated with the one or more Machine Type Communication (MTC) devices in an uplink direction, according to an exemplary embodiment of the present invention;

FIG. 4 is a flowchart illustrating an exemplary method of transmitting PDUs associated with the MTC devices over a S1 interface, according to another exemplary embodiment of the present invention;

FIG. 5 illustrates a schematic representation of a General Packet Radio Service (GPRS) Tunneling Protocol (GTP) header of a GTP PDU containing concatenated PDUs, according to an exemplary embodiment of the present invention;

FIG. 6 illustrates a schematic representation of a concatenated GTP User Plane (GTP-U) PDU header, according to an exemplary embodiment of the present invention; and

FIG. 7 illustrates a block diagram of an evolved Node B (eNodeB) showing various components for implementing the eNodeB, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents

It is to be understood that the singular forms “a,” “an,” and “the” include plural referents unless the context clearly dictates otherwise. Thus, for example, reference to “a component surface” includes reference to one or more of such surfaces.

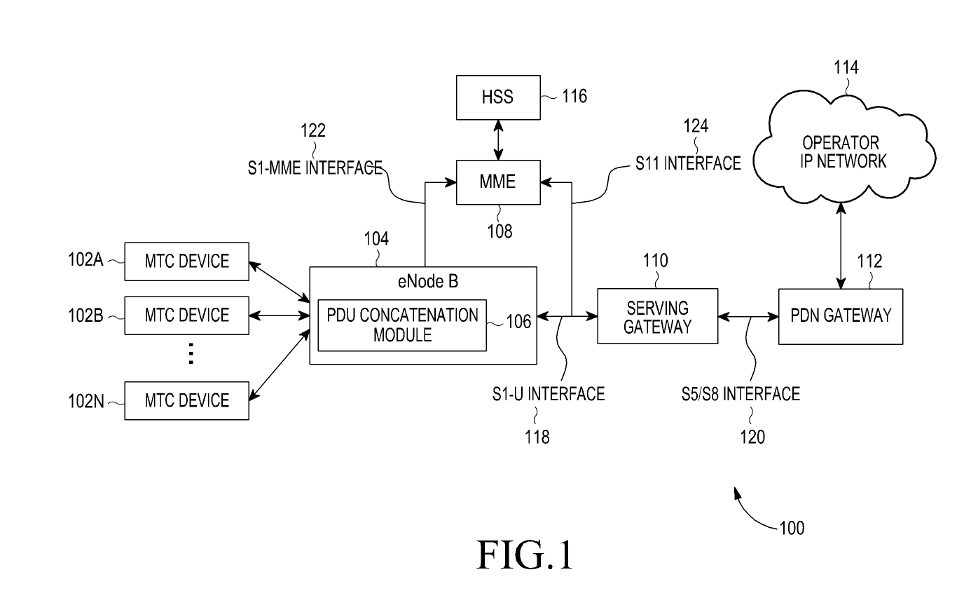

FIG. 1 illustrates a block diagram of a Long Term Evolution (LTE) system, according to an exemplary embodiment of the present invention.

Referring to FIG. 1, an LTE system 100 includes Machine Type Communication (MTC) devices 102A to 102N, an evolved Node B (eNodeB) 104, a Mobility Management Entity (MME) 108, a serving gateway 110, a Packet Data Network (PDN) gateway 112, an operator Internet Protocol (IP) network 114, and a Home Subscriber Server (HSS) 116. The above entities are connected to each other via standardized interfaces, which may also be referred to as network interfaces, or any other similar and/or suitable connection type. For example, the eNodeB 104 and the MME 108 are connected via an S1-MME interface 122. Also, the eNodeB 104 and the serving gateway 110 are connected via an S1-U interface 118. Furthermore, the serving gateway 110 is connected to the MME 108 and the PDN gateway 112 via an S11 interface 124 and an S5/S8 interface 120, respectively. For the purpose of illustration, only one eNodeB is illustrated. However, the present invention is not limited thereto, and there may be more than one eNodeB in the LTE system 100. Also, each eNodeB may be configured to support MTC devices and/or Legacy devices.

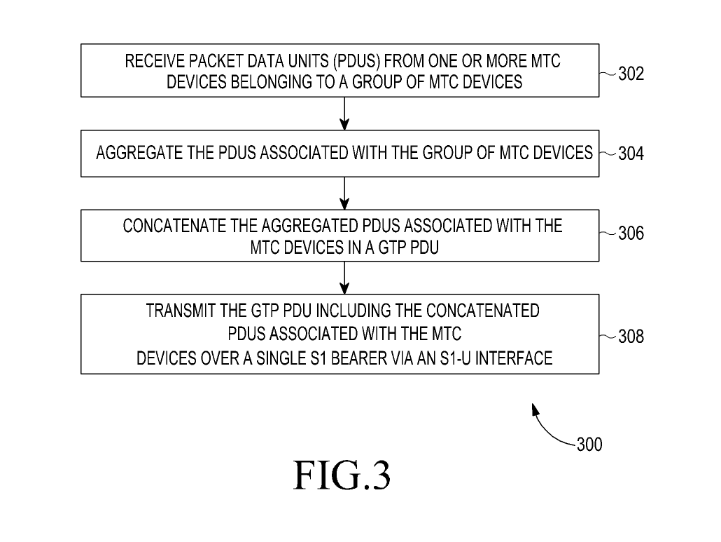

According to an exemplary embodiment of the present invention, the eNodeB 104 includes a Packet Data Units (PDU) concatenation module 106 operable for efficiently transmitting PDUs from one or more MTC devices 102A-102N over a single S1-U bearer via the S1-U interface 118. The PDU concatenation module 106 may concatenate PDUs received from a single MTC device 102A or a group of MTC devices 102A-102N in a General Packet Radio Service (GPRS) Tunneling Protocol (GTP) PDU. According to exemplary embodiments, the MME 108 may instruct the PDU concatenation module 106 to store the PDUs associated with the MTC device 102A or the group of MTC devices 102A-102N according to a load condition at the S1-U interface. In these exemplary embodiments, the PDU concatenation module 106 aggregates the PDUs received from the MTC devices 102A-120N and concatenates the aggregated PDUs in a GTP PDU. The PDU concatenation module 106 then transmits the GTP PDU having the concatenated PDUs to the serving gateway 110 over a single S1-U bearer via the S1-U interface 118. The process steps performed by the PDU concatenation module 106 in uplink are described in greater detail with reference to FIG. 3.

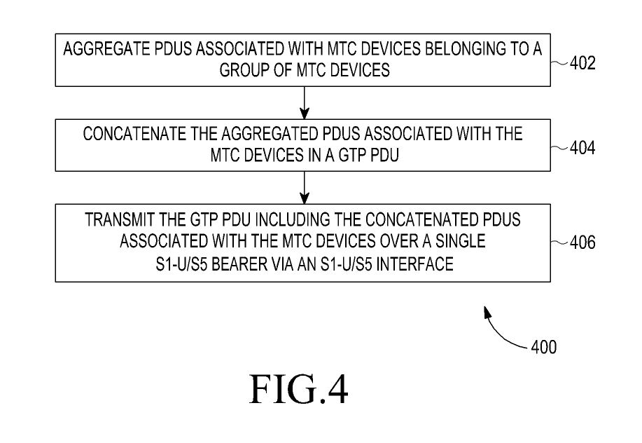

Although, FIG. 1 illustrates that the PDU concatenation module 106 is disposed in the eNodeB, the present invention is not limited thereto, and the serving gateway 110 and PDN gateway 112 may also have the PDU concatenation module 106 or the PDU concatenation module 106 may be disposed in any suitable and/or similar manner. For example, when the PDU concatenation module 106 resides in the serving gateway 110, the PDU concatenation module 106 may concatenate PDUs intended for one or more MTC devices 102A-102N in a GTP PDU and transmit the GTP PDU containing the concatenated PDUs to the eNodeB 104 in downlink over a single S5 bearer. The PDU concatenation module 106 concatenates PDUs and transmits the concatenated PDUs based on an overload indication from the MME 108. The same functionality may be performed at the PDN gateway 112 when the PDU concatenation module 106 resides in the PDN gateway 112. The process steps performed by the PDU concatenation module 106 in downlink are described in greater detail with reference to FIG. 4.

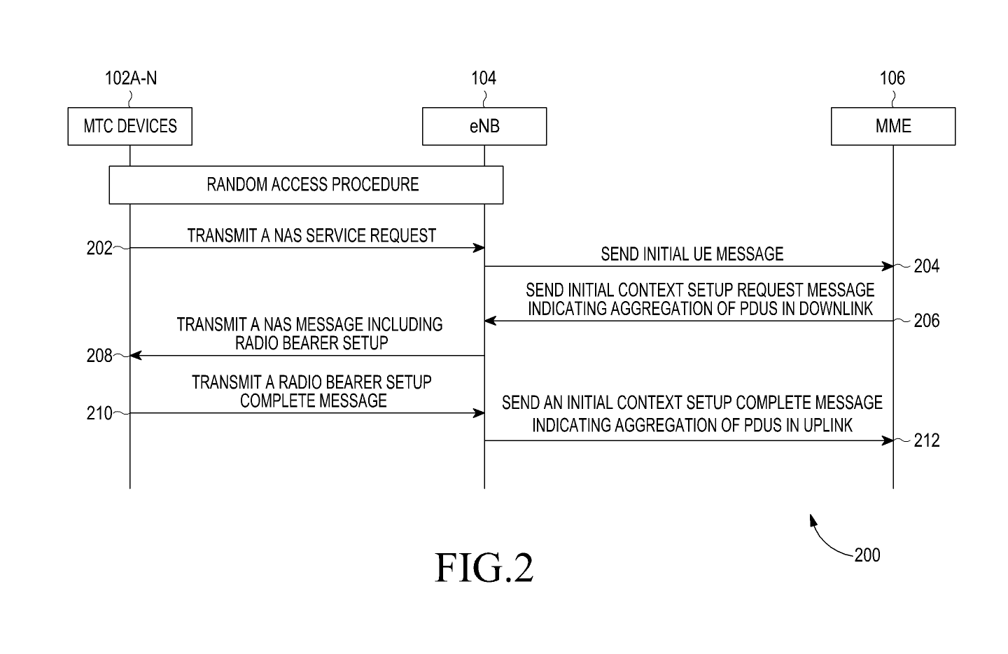

FIG. 2 is a flow diagram illustrating an exemplary method of notifying an aggregated PDU indication during a call establishment procedure, according to an exemplary embodiment of the present invention.

Referring to FIG. 2, in a procedure 200, at step 202, the MTC device 102A transmits a Non-Access Stratum (NAS) service request to the eNodeB 104 upon completion of a random access procedure between the MTC device 102A and the eNodeB 104. At step 204, the eNodeB 104 sends an initial User Equipment (UE) message, which includes the NAS service request and an eNode-MTC device signaling connection identifier, to the MME 108.

At step 206, the MME 108 sends an initial context setup request message indicating aggregation of PDUs in an uplink direction, and also indicating an MME-MTC device signaling connection ID, a security context, and capability information to the eNodeB 104. According to an exemplary embodiment, the eNodeB 104 becomes aware that the S1-U interface is overloaded and hence PDUs need to be aggregated according to the aggregated PDU indication in the initial context setup message.

At step 208, the eNodeB 104 transmits a NAS message, which includes a radio bearer setup, to the MTC device 102A. At step 210, the MTC device 102A transmits a radio bearer setup complete message to the eNodeB 104 in response to the radio bearer setup of step 208. At step 212, the eNodeB 104 sends an initial context setup complete message indicating aggregation of the PDUs in the uplink direction.

FIG. 3 is a flowchart illustrating an exemplary method of transmitting PDUs associated with the one or more MTC devices in an uplink direction, according to an exemplary embodiment of the present invention.

Referring to FIG. 3, at step 302, PDUs are received from one or more of the MTC devices 102A-102N belonging to a group including the MTC devices 102A-102N. The MTC devices 102A-102N are grouped by the MME 108 for concatenating PDUs. The MTC devices 102A-102N included in the group are assigned a group identifier by the MME 108 so that the eNodeB 104 can identify the PDUs received from the one or more MTC devices 102A-102N belonging to the group. Alternatively, when a group of MTC devices 102A-102N exists by itself, then the group identifier assigned to the existing group is used for concatenating PDUs.

At step 304, the PDUs received from the MTC devices 102A-102N are aggregated so as to be associated with the group of the MTC devices 102A-102N, and may be stored in a memory of the eNodeB 104. In some exemplary embodiments, a notification indicating that the S1-U interface 118 is overloaded or may become overloaded is received from the MME 108 during a call establishment procedure as illustrated in FIG. 2. In these exemplary embodiments, the PDUs received from the MTC devices 102A-102N are temporarily stored in the memory since the S1-U interface 118 is overloaded. Alternatively, the eNodeB 104 may send a notification to the MME 108 indicating that the PDUs are being aggregated at the eNodeB 104. Furthermore, the PDUs are aggregated for a predetermined period of time until a predetermined size of PDUs is met or until the S1-U interface 118 is not overloaded, i.e., until it is determined that the S1-U interface 118 is free for transmission. For example, the predetermined size of the aggregated PDUs may be equal to or less than a total size of a payload field of a GTP PDU, or the predetermined size may be any suitable and/or similar size.

At step 306, the aggregated PDUs are concatenated into a single GTP PDU. The aggregated PDUs are concatenated in a GTP payload and information, such as the aggregated PDU indication, a number of aggregated PDUs, a length of each of the aggregated PDUs, and other similar and/or suitable information, is encoded in a GTP header of the GTP PDU. At step 308, the GTP PDU, including the concatenated PDUs, is transmitted to the serving gateway 110 over a single S1-U bearer via the S1-U interface 118. According to an exemplary embodiment, the GTP PDU including the concatenated PDUs may be transmitted to the serving gateway 110 when there is no overload at the S1-U interface 118. The MME 108 may indicate that the GTP PDU may be transmitted to the serving gateway 110 via the S1-U interface 118 when there is no overload at the S1-U interface 118. Accordingly, the serving gateway 110 may transmit the GTP PDU including the concatenated PDUs to the PDN gateway 112 over the S5 interface 120.

FIG. 4 is a flowchart illustrating an exemplary method of transmitting PDUs associated with the MTC devices over a S1-U interface, according to another exemplary embodiment of the present invention.

Referring to FIG. 4, at step 402 of a procedure 400, PDUs associated with the MTC devices 102A-102N, which belong to the group of MTC devices 102A-102N, are aggregated at the serving gateway 110. The PDUs received from the PDN gateway 112 are aggregated at the serving gateway 110 upon receiving an indication from the MME 108 that the S1-U interface 118 is getting overloaded or is overloaded. At step 404, the aggregated PDUs are concatenated in a GTP PDU having a GTP header and a GTP payload, wherein the GTP header includes an aggregated PDU indication, a number of aggregated PDUs and a length of each PDU, and the GTP payload includes the aggregated PDUs. At step 406, the GTP PDU including the concatenated PDUs is transmitted to the eNodeB 104 over a single S1-U bearer via the S1-U interface 118. The eNodeB 104, upon receiving the GTP PDU, obtains the concatenated PDUs from the GTP payload and sends respective PDUs to each of the MTC devices 102A-102N.

FIG. 5 illustrates a schematic representation of a GTP header of a GTP PDU containing concatenated PDUs, according to an exemplary embodiment of the present invention.

Referring to FIG. 5, a GTP header 500 includes a next extension header type field 502 which indicates a type of a next extension header following a particular extension header. The next extension type field 502 indicates one of the following values given in Table 1 below:

TABLE 1

| Next Extension | |
|---|---|
| Header Field Value | Type of Extension Header |
| 0000 0000 | No more extension headers |
| 0000 0001 | Reserved - Control Plane only |
| 0000 0010 | Reserved - Control Plane only |
| 0100 0000 | UDP Port. Provides the UDP Source |
| | Port of the triggering message |
| 1100 0000 | PDCP PDU Number [4]-[5] |
| 1100 0001 | Reserved - Control Plane only |
| 11000010 | Reserved - Control Plane only |
| 1110 0000 | Concatenated GTP-U PDU |

According to an exemplary embodiment, the new extension header type field 502 may carry a value ‘1110 0000’ when a next extension header is concatenated GTP-U PDU header.

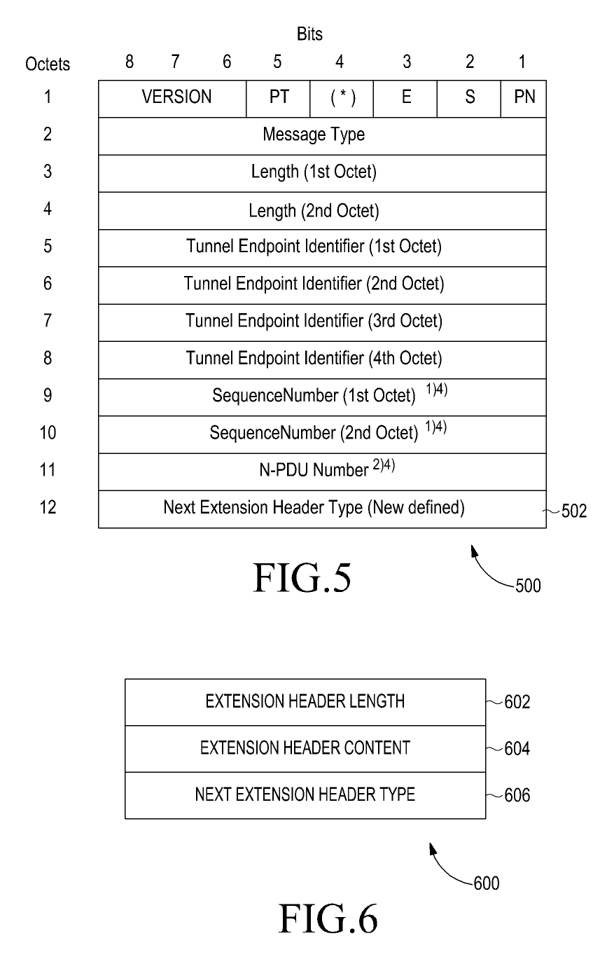

FIG. 6 illustrates a schematic representation of a concatenated GTP-U PDU header, according to an exemplary embodiment of the present invention.

Referring to FIG. 6, a GTP-U PDU header 600 includes an extension header length field 602, an extension header content field 604, and a next extension header type field 606. The extension header length field 604 may indicate length of the concatenated GTP-U PDU header 600. The extension header content field 604 may indicate a number of concatenated PDUs in the GTP payload and a length of each of the concatenated PDUs. The next extension header type field 606 may indicate a type of next extension header following the concatenated GTP-U header 600.

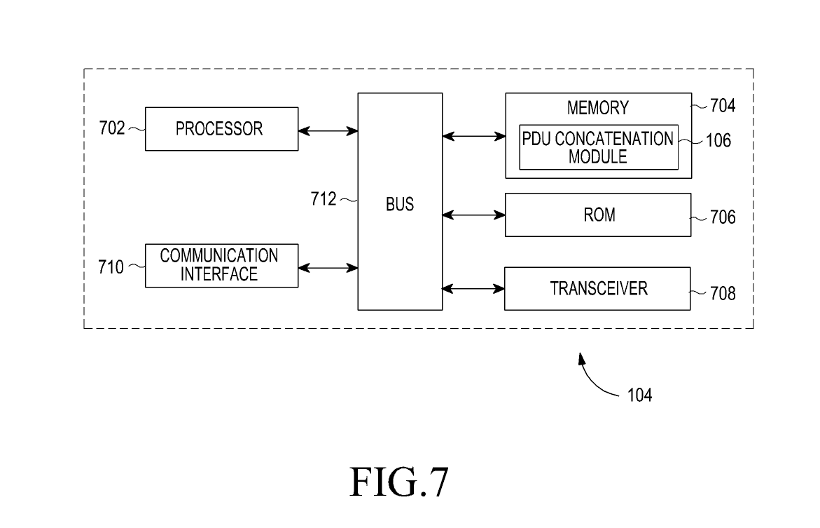

FIG. 7 illustrates a block diagram of an eNodeB showing various components for implementing the eNodeB, according to an exemplary embodiment of the present invention.

Referring to FIG. 7, the eNodeB 104 includes a processor 702, a memory 704, a Read Only Memory (ROM) 706, a transceiver 708, and a bus 712. The processor 702, according to the present exemplary embodiment, may be any type of physical computational circuit or hardware, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, an integrated circuit, an application specific integrated circuit, or any other type of similar and/or suitable processing circuit. The processor 702 may also include embedded controllers, such as generic or programmable logic devices or arrays, application specific integrated circuits, single-chip computers, smart cards, and the like.

The memory 704 may be volatile memory and non-volatile memory. The memory 704 includes the PDU concatenation module 108 for aggregating the PDUs received from one or more MTC devices 102A-102N and for concatenating the aggregated PDUs into a single GTP PDU, according to the exemplary embodiments described above. A variety of computer-readable storage media may be stored in and accessed from memory elements of the memory 704. The memory elements may include any number of suitable memory devices for storing data and machine-readable instructions, such as a ROM, a Random Access Memory (RAM), an Erasable Programmable Read Only Memory (EPROM), an Electrically EPROM (EEPROM), a hard drive, a removable media drive for handling memory cards, memory sticks, and any other similar and/or suitable type of memory storage device and/or storage media.

Exemplary embodiments of the present invention may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 702. For example, a computer program may include machine-readable instructions for aggregating the PDUs received from one or more MTC devices 102A-102N and for concatenating the aggregated PDUs into a single GTP PDU, according to the exemplary embodiments of the present invention. According to an exemplary embodiment, the computer program may be included on a storage medium and loaded from the storage medium to a hard drive in the non-volatile memory. The transceiver 708 is configured for transmitting the GTP PDU including the concatenated PDUs to the serving gateway 110 over a single S1-U bearer via the S1-U interface 118.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A Machine Type Communication (MTC) method, the method comprising:
aggregating Packet Data Units (PDUs), the aggregated PDUs being associated with at least one MTC device, by a first network entity in a Long Term Evolution (LTE) network environment;
concatenating_the aggregated PDUs associated with the at least one MTC device into a General Packet Radio Service (GPRS) Tunneling Protocol (GTP) PDU; and
transmitting the GTP PDU, the GTP PDU including the concatenated PDUs, to a second network entity over a network interface_connecting the first network entity and the second network entity.

2. The method of claim 1, wherein the aggregating of the PDUs by the first network entity comprises:
receiving a notification, from a Mobility Management Entity (MME) during a call establishment procedure, indicating that the network interface connecting the first network entity and the second network entity is overloaded; and
aggregating, by the first network entity, the PDU associated with the at least one MTC device according to the notification.

3. The method of claim 1, wherein the concatenating of the aggregated PDUs associated with the at least one MTC device into the GTP PDU comprises:
encoding an aggregated PDU indication, a number of aggregated PDUs, and a length of each of the aggregated PDUs in a GTP header of the GTP PDU; and
concatenating the aggregated PDUs in a GTP payload of the GTP PDU.

4. The method of claim 1, wherein the first network entity and the second network entity are selected from among a group consisting of an evolved Node B (eNodeB), a serving gateway, and a Packet Data Network PDN gateway.

5. The method of claim 4, wherein the transmitting of the GTP PDU to the second network entity over the network interface comprises:
selecting the network interface from among a group consisting of an S1-U interface and an S5 interface.

6. The method of claim 5, wherein the transmitting of the GTP PDU to the second network entity over the network interface comprises:
transmitting the GTP PDU to the second network entity via the S1-U or the S5 interface over a single S1-U bearer or a single S5 bearer.

7. The method of claim 1, further comprising:
transmitting a notification to a Mobility Management Entity (MME), the notification indicating that PDUs associated with the at least one MTC device are being aggregated at the first network entity.

8. The method of claim 1, further comprising:
receiving a notification from a Mobility Management Entity (MME) to aggregate PDUs associated with the at least one MTC device at the first network entity.

9. The method of claim 1, further comprising:
grouping the at least one MTC device in a group having a group IDentification (ID) for concatenating PDUs associated with the at least one MTC device.

10. A Machine Type Communication (MTC) apparatus, the apparatus comprising:
a processor; and
a memory coupled to the processor,
wherein the memory includes a PDU concatenation module configured for:
aggregating Packet Data Units (PDUs)_associated with at least one MTC device in a Long Term Evolution (LTE) network environment;
concatenating_the aggregated PDUs associated with the at least one MTC device into a General Packet Radio Service (GPRS) Tunneling Protocol (GTP) PDU; and
transmitting the GTP PDU, the GTP PDU including the concatenated PDUs, to a network entity over at least one of an S1-U interface and an S5 interface.

11. The apparatus of claim 10, wherein the PDU concatenation module receives a notification, from a Mobility Management Entity (MME) during a call establishment procedure, indicating that the at least one of the S1-U interface and the S5 interface is overloaded, and
wherein the PDU concatenation module aggregates the PDUs associated with the at least one MTC device according to the notification.

12. The apparatus of claim 10, wherein the PDU concatenation module encodes an aggregated PDU indication, a number of aggregated PDUs, and a length of each of the aggregated PDUs in a GTP header of the GTP PDU, and
wherein the PDU concatenation module concatenates the aggregated PDUs in a GTP payload of the GTP PDU.

13. The apparatus of claim 10, wherein, when the PDU concatenation module transmits the GTP PDU to the serving gateway over the at least one of the S1-U interface and the S5 interface, the PDU concatenation module transmits the GTP PDU to the network entity via the at least one of S1-U interface and the S5 interface over at least one of a single S1-U bearer and a single S5 bearer.

14. The apparatus of claim 10, wherein the PDU concatenation module is configured for transmitting a notification to a Mobility Management Entity (MME), the notification indicating that PDUs associated with the at least one MTC device are being aggregated.

15. The apparatus of claim 10, wherein the PDU concatenation module is configured for receiving instructions from a Mobility Management Entity (MME) to aggregate PDUs associated with the at least one MTC device.

16. The apparatus of claim 10, wherein the PDU concatenation module is configured for grouping the at least one MTC device in a group having a group IDentification (ID) in order to concatenate PDUs associated with the at least one MTC device.

17. The apparatus of claim 10, wherein the network entity is selected from the group consisting of an evolved Node B (eNodeB), a serving gateway, and a Packet Data Network (PDN) gateway.
